(19) United States
(12) Patent Application Publication
(10) Pub. No.: US 2024/0117871 A1
(43) Pub. Date: Apr. 11, 2024

(54) CHAINRING

(71) Applicant: Fox Factory, Inc., Duluth, GA (US)

(72) Inventors: Paul KLAWER, North Vancouver (CA); Wesley E. ALLINGER, Santa Cruz, CA (US)

(73) Assignee: Fox Factory, Inc., Duluth, GA (US)

(21) Appl. No.: 18/134,944

(22) Filed: Apr. 14, 2023

Related U.S. Application Data
(63) Continuation of application No. 16/784,675, filed on Feb. 7, 2020, now Pat. No. 11,680,633.
(60) Provisional application No. 62/803,250, filed on Feb. 8, 2019.

(51) Int. Cl. F16H 55/30; B62M 9/02

(52) U.S. Cl. CPC F16H 55/30; B62M 9/02

(57) ABSTRACT

A chainring is disclosed herein. The chainring includes a front surface, a back surface, a center, and an outer diameter. The chainring has a thickness which varies from a lesser thickness at the outer diameter to a greater thickness nearer the center. The thickness of the chainring varying substantially the same on the front surface and the back surface such that the chainring is substantially symmetric about a plane dividing the front surface and the back surface along a direction normal to an axial direction of the chainring.

### CROSS-REFERENCE TO RELATED APPLICATIONS

This application claims priority to and benefit of co-pending U.S. patent application Ser. No. 16/784,675 filed on Feb. 7, 2020, entitled “CHAINRING” by Klawer et al., and assigned to the assignee of the present application, the disclosure of which is hereby incorporated by reference in its entirety.

The application Ser. No. 16/784,675 claims priority to and benefit of U.S. Provisional Patent Application No. 62/803,250 filed on Feb. 8, 2019, entitled “CHAINRING” by Klawer et al., and assigned to the assignee of the present application, the disclosure of which is hereby incorporated by reference in its entirety.

### FIELD OF THE INVENTION

Embodiments of the invention generally relate to a chainring for a chain, belt, or shaft driven vehicle.

### BACKGROUND

In a bicycle, such as a mountain bike, electric bike (eBike), or the like, a strong and rigid chainring is desired.

### BRIEF DESCRIPTION OF THE DRAWINGS

Aspects of the present invention are illustrated by way of example, and not by way of limitation, in the accompanying drawings, wherein:

FIG. 1 is perspective view of a front (or outboard) surface of a chainring, in accordance with an embodiment.

FIG. 2 is perspective view of a back (or inboard) surface of a chainring, in accordance with an embodiment.

FIG. 3 is a side view of chainring, in accordance with an embodiment.

FIG. 4 is a diagram including a plurality of detailed views of a chainring and various portions of the chainring, in accordance with an embodiment.

FIG. 5 is an enlarged view of view of FIG. 4, in accordance with an embodiment.

FIG. 6 is an enlarged view of view of FIG. 4, in accordance with an embodiment.

FIG. 7 is an enlarged view of view of FIG. 4, in accordance with an embodiment.

FIG. 8 is an enlarged view of view of FIG. 4, in accordance with an embodiment.

FIG. 9 is an enlarged view of view of FIG. 4, in accordance with an embodiment.

FIG. 10 is an enlarged view of view of FIG. 4, in accordance with an embodiment.

FIG. 11 includes a plan view of the back surface of a chainring and a plan view of the front surface of a chainring, in accordance with an embodiment.

The drawings referred to in this description should be understood as not being drawn to scale except if specifically noted.

### DESCRIPTION OF EMBODIMENTS

The detailed description set forth below in connection with the appended drawings is intended as a description of various embodiments of the present invention and is not intended to represent the only embodiments in which the present invention is to be practiced. Each embodiment described in this disclosure is provided merely as an example or illustration of the present invention, and should not necessarily be construed as preferred or advantageous over other embodiments. In some instances, well known methods, procedures, and objects have not been described in detail as not to unnecessarily obscure aspects of the present disclosure.

In the following discussion, the chainring is part of a vehicle drive assembly. For example, the chainring receives an input force (from an engine, a human working the pedals, or the like) that causes the chainring to rotate (at a certain speed, with a certain amount of force, etc.). The chainring is coupled to a transfer system (such as a roller chain, belt, shaft, or the like), which transfers the force from the chainring to the drive system (the transfer could be backward, forward, up, down, or a combination thereof. The drive system could be another chainring, a sprocket, a cassette, or the like which is mechanically coupled to at least one drive wheel. In so doing, at least a portion of the input force received at the chainring is ultimately transferred to the drive wheel (or wheels) thereby causing motion. In one example, e.g., a bike, the chainring is part of the crankset and is used to transfer power provided from the rider through the pedals to the rear (or driving) wheel. In another example, e.g., a motorized vehicle having at least one wheel, the chainring is mechanically coupled with the engine and is used to transfer power provided from the engine through the drive system to the rear (or driving) wheel (axle, or the like).

In one embodiment, the teeth on the chainring are designed and spaced to, typically, engage with openings in the links of a roller chain. In another embodiment, such as a belt drive (instead of chain drive), the teeth on the chainring are designed and spaced to, typically, engage with grooves or other features of a belt. In one embodiment, such as a shaft drive (instead of chain drive), a shaft is designed to couple with the outer diameter of the chainring.

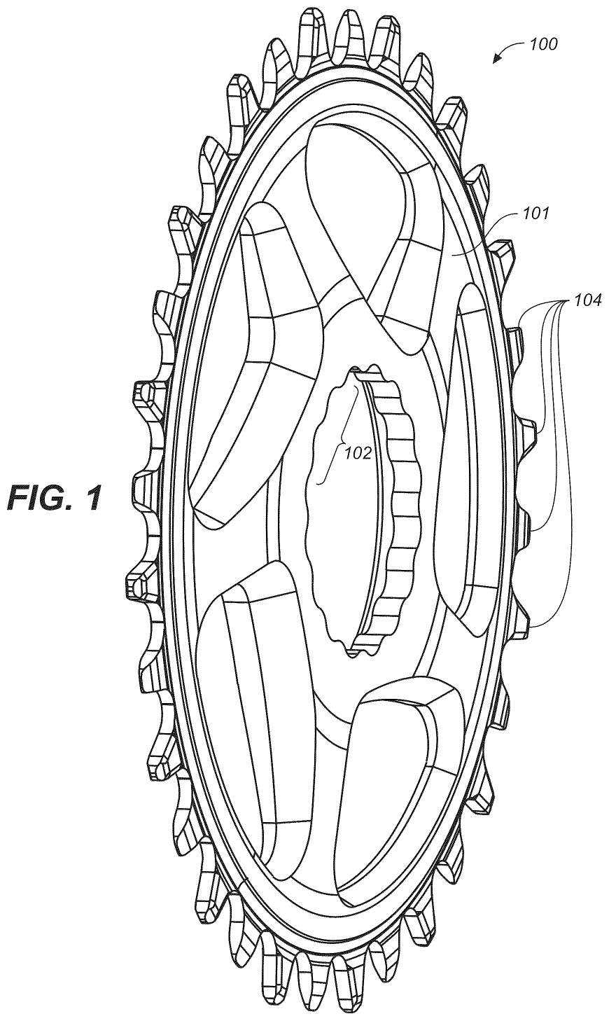

FIG. 1 is a perspective view of a chainring 100, in accordance with an embodiment of the present invention. More specifically, FIG. 1 is a perspective view of the front surface 101 of the chainring 100. In one embodiment, chainring 100 consists of a single material such as aluminum, titanium, steel, or the like. In one embodiment, chainring 100 consists of a composite material such as injection molded carbon fiber, carbon fiber with reinforced nylon, compression molding, composite layering, nylon reinforced with carbon fibers, chopped carbon fibers, a plastic, polymer, other long fiber-reinforced plastics, or the like. In one embodiment, chainring 100 could be formed from a combination of the materials.

It will be noted that front surface 101 (sometimes referred to as the “outboard” surface) is, typically, the surface at which a crank arm of a crankset will engage with chainring 100. It will be understood that a crank set will typically include various components including, for example, but not limited to, pedals, pedal washers, preloader, dust caps, spindle spacers, bearings, hex nuts, preload adjusters, and the like. The various components of a crank set not shown in the present Figures for purposes of clarity and to avoid unnecessarily obscuring aspects and features of chainring 100.

Further, in the embodiment of FIG. 1, chainring 100 includes an interface, having a typical portion thereof denoted as surface 102, for typically engaging with, for example, the crank arm of the crank set. It should be noted that, in the present chainring 100, surface 102 may also engage with a spindle, or any other portion of the crank set depending upon the particular configuration and components comprising the crank set. Chainring 100 also includes a plurality of teeth, typically shown as teeth 104, which are disposed about an outer perimeter of chainring 100. In one embodiment of chainring 100, the dimensions of teeth 104 very, alternately, from a thinner and more beveled tooth to a thicker and less beveled tooth. A specific example of measurements corresponding to such an alternating tooth configuration is shown at FIG. 10. It will be understood, however, that embodiments of the present chainring 100 are well suited to use with various tooth configurations, tooth patterns and/or tooth dimensions.

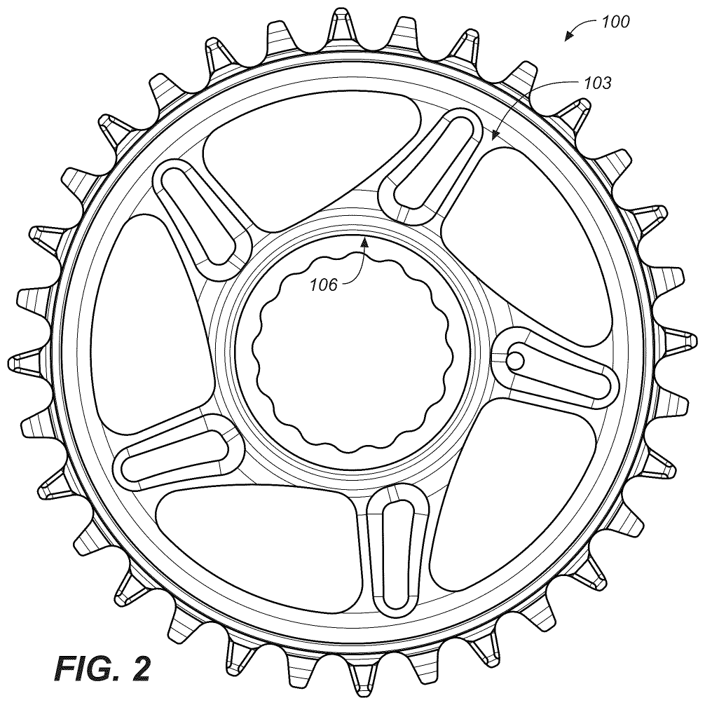

With reference now to FIG. 2, a perspective view of a chainring 100 is provided, in accordance with an embodiment of the present invention. More specifically, FIG. 2 is a perspective view of the back surface 103 of chainring 100. It will be noted that back surface 103 (sometimes referred to as the “inboard” surface) includes a depressed region 106. Depressed region 106 of chainring 100 typically engages with, for example, the spindle of the crank set. It should be noted that, in the present chainring 100, depressed region 106 may also engage with any other portion of the crank set depending upon the particular configuration and components comprising the crank set.

In one embodiment, depressed region 106 of chainring 100 is depicted as formed within back surface 103. It is important to note that in various embodiments of the present invention, depressed region 106 may be formed in front surface 101. Further, in various embodiments of the present invention, a depressed region may be formed in both front surface 101 and back surface 103. Also, in various embodiments of the present invention, depressed region 106 (whether formed in one or more of front surface 101 and back surface 103) can be formed having a greater or lesser depth than depicted in FIG. 2. As a result, chainring 100 is well suited to embodiments in the location of depressed region 106 can be formed extending into either front surface 101 or back surface 103. Further, chainring 100 is well suited to embodiments in which the depth of depressed region 106 can vary from extending slightly into either front surface 101 or back surface 103, up to extending (into either front surface 101 or back surface 103) a distance which is nearly equal to the maximum thickness of chainring 100.

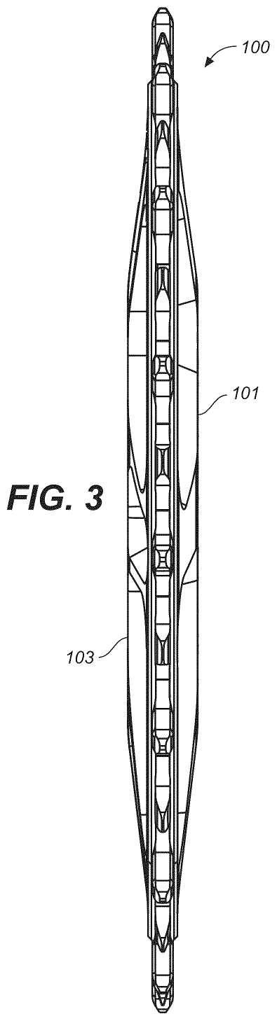

With reference now to FIG. 3, a side view of chainring 100 is provided. In the present embodiment, and as clearly depicted in FIG. 3, chainring 100 has a thickness which varies from a lesser thickness at the outer diameter (e.g., near teeth 104) to a greater thickness nearer the center (e.g., near surface 102) of chainring 100. Further, in one embodiment, the thickness of chainring 100 varies substantially the same on both front surface 101 and back surface 103. In such an embodiment, chainring 100 is substantially symmetric about a plane dividing front surface 101 and back surface 103 along the direction normal to the axial direction of chainring 100. Such varying thickness and substantially symmetrical shape provide increased lateral strength for chainring 100 as compared to conventional planar and/or non-substantially symmetrical chainrings. Additionally, the varying thickness and substantially symmetrical shape of chainring 100 achieve a substantially uniform rigidity with respect to both the inboard direction and the outboard direction when chainring 100 is in use.

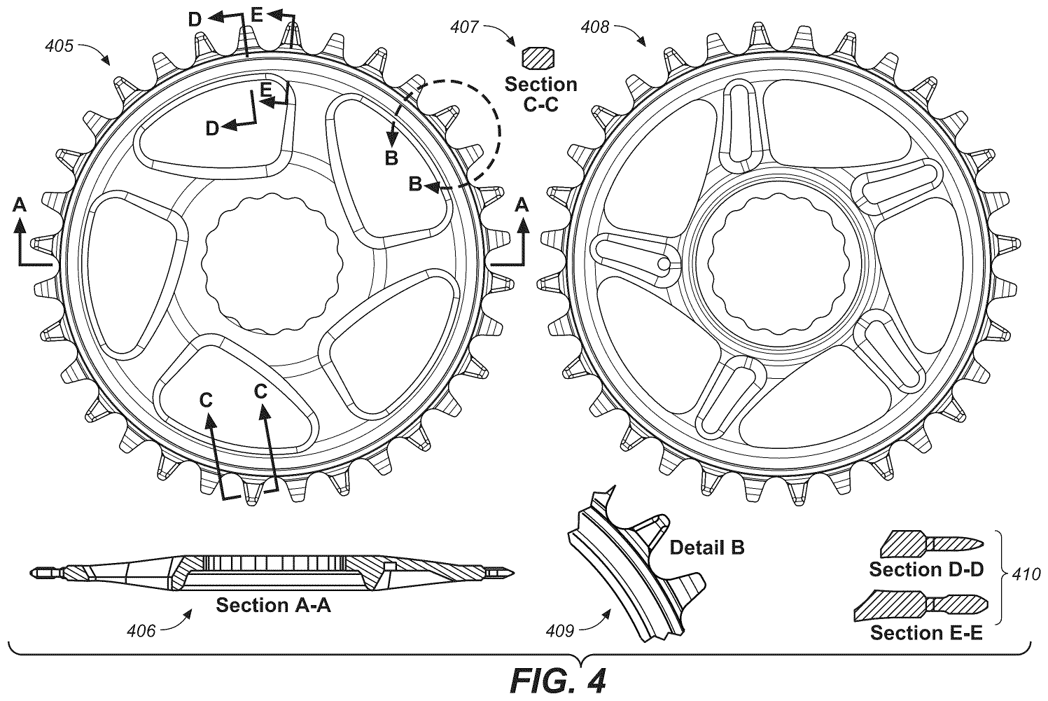

Referring still to FIG. 3, and as shown in the various views of FIG. 4, in one embodiment, chainring 100 has a total maximum thickness of 9.5 millimeters. It will be understood that in another embodiment, the present chainring 100 may have a greater or lesser maximum thickness. Also, the varying thickness and substantially symmetrical shape of chainring 100 is well suited being formed by forging, forming, and/or casting processes. In one embodiment, chainring 100 is comprised of a single material such as aluminum, titanium, steel, or the like. In some embodiments, chainring 100 is comprised of a composite material such as injection molded carbon fiber, carbon fiber with reinforced nylon, compression molding, composite layering, nylon reinforced with carbon fibers, chopped carbon fibers, a plastic, polymer, other long fiber-reinforced plastics, or the like. In some embodiments, chainring 100 is formed from a combination of materials such as, for example, a single material for teeth 104 and an inner composite material for the remainder of chainring 100. In one such embodiment, the single material will have a higher modulus of elasticity than that of the composite material.

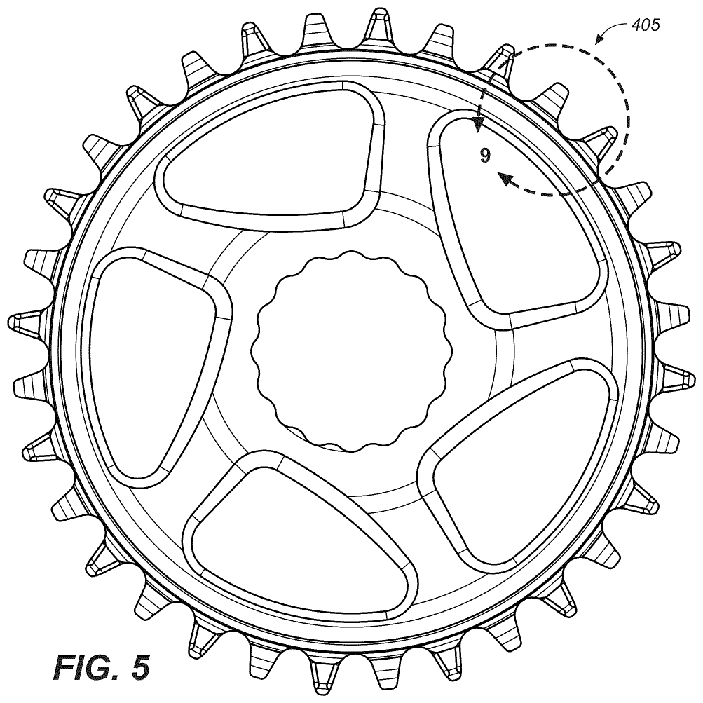

With reference now to FIG. 4, a diagram including a plurality of detailed views of chainring 100 and various portions of chainring 100 is provided, in accordance with an embodiment. In the plurality of views of FIG. 4 (and also in FIGS. 5-10) various measurements are provided for components and features of chainring 100. Although such measurements are shown for chainring 100, it should be appreciated that the provided measurements comprise one or more embodiments and that the measurements of the components and features of chainring 100 can be adjusted based upon, for example, user preferences, performance needs, application requirements (e.g., on-road, downhill, offroad, uphill, etc.), vehicle frame size, and the like.

FIG. 5 is an enlarged view of view 405 of FIG. 4 including a number of measurements for features and aspects of front surface 101 of chainring 100. Although a number of measurements are provided in FIG. 5, it should be appreciated that the provided measurements comprise one embodiment and that one or more of the measurements could be adjusted and/or modified as stated above.

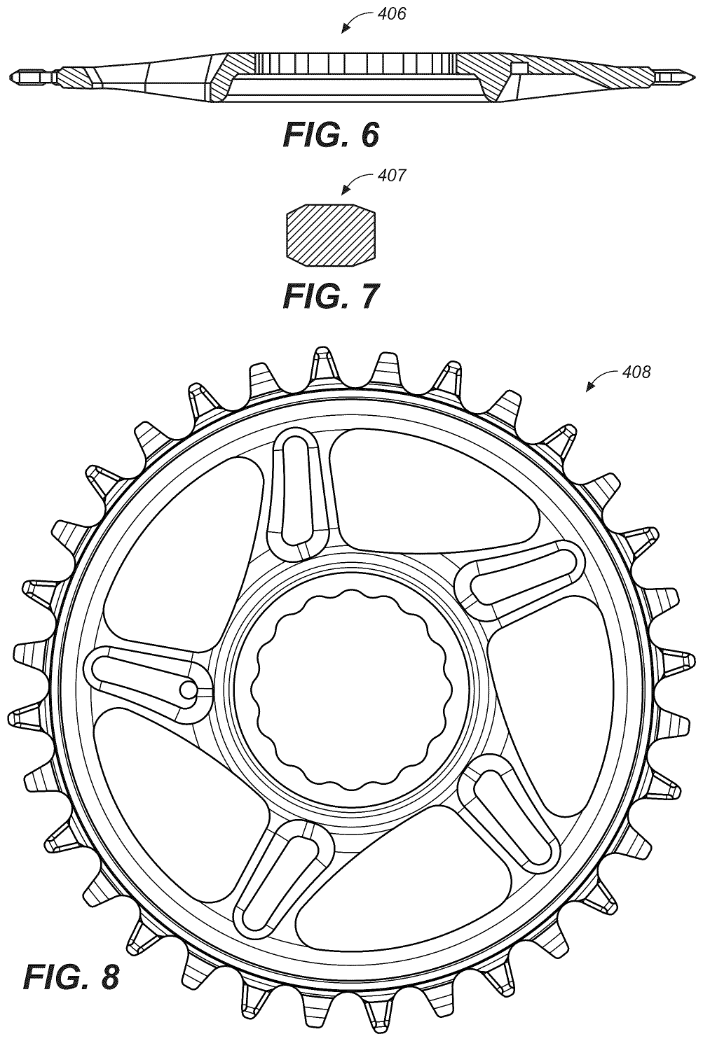

FIG. 6 is an enlarged view of view 406 of FIG. 4 including a number of measurements for features and aspects readily depicted in a side view of chainring 100. Although a number of measurements are provided in FIG. 6, it should be appreciated that the provided measurements comprise one embodiment and that one or more of the measurements could be adjusted and/or modified as stated above.

FIG. 7 is an enlarged view of view 407 of FIG. 4 including a plan view of tooth 104 of chainring 100 and a measurement for features and aspects related to the beveled shape of tooth 104. Although such a measurement is provided in FIG. 7, it should be appreciated that the provided measurement comprises one embodiment and that the measurement could be adjusted and/or modified as stated above.

FIG. 8 is an enlarged view of view 408 of FIG. 4 including a description of a formation process for a feature of back surface 103 of chainring 100. Although a particular formation process is provided in FIG. 8, it should be appreciated that the feature can be formed in any of numerous other formation processes.

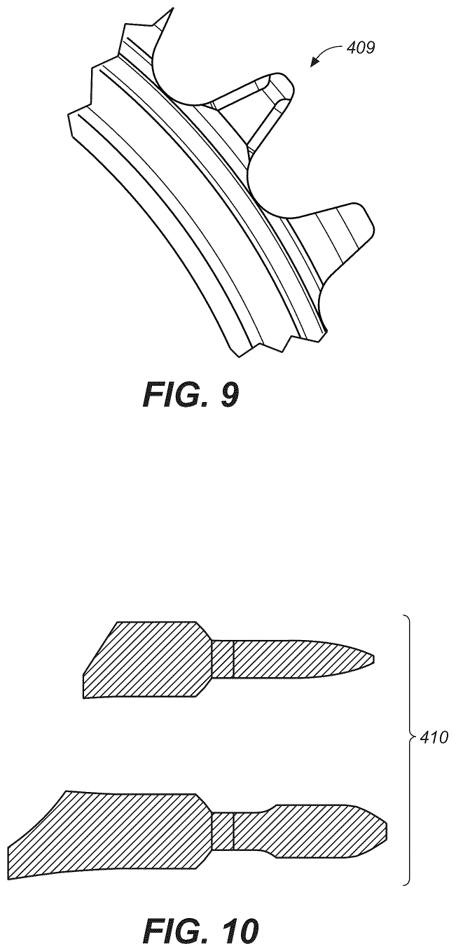

FIG. 9 is an enlarged view of view 409 of FIG. 4 including a number of measurements for teeth 104 of chainring 100 and a measurement for features and aspects related to teeth 104. Although such measurements are provided in FIG. 9, it should be appreciated that the provided measurements comprises one embodiment and that the measurements could be adjusted and/or modified as stated above.

FIG. 10 is an enlarged view of view 410 of FIG. 4 including a number of measurements for teeth 104 of chainring 100 and measurements for features and aspects related to teeth 104. Although such measurements are provided in FIG. 10, it should be appreciated that the provided measurements comprises one embodiment and that the measurements could be adjusted and/or modified as stated above.

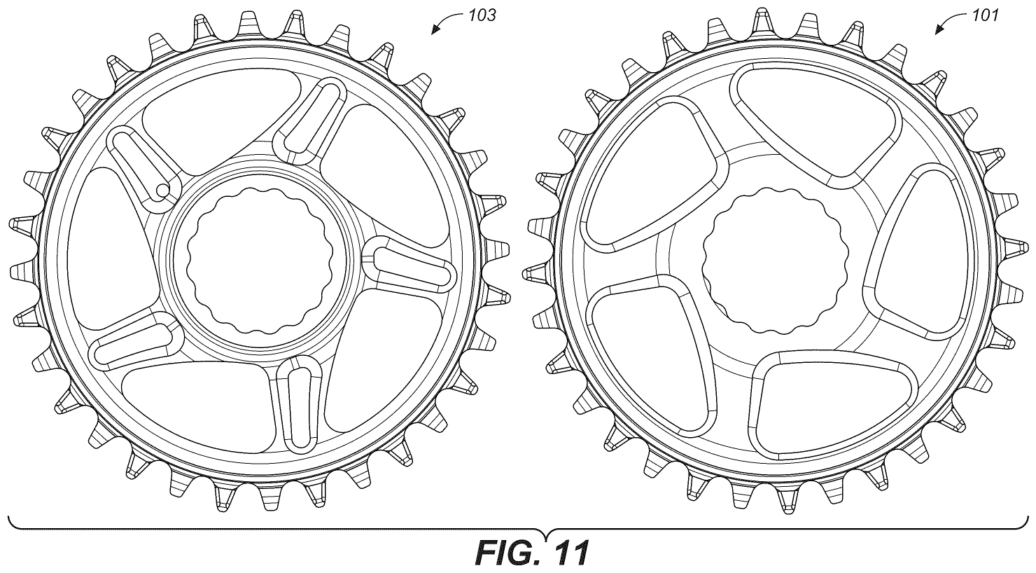

FIG. 11 is a perspective view of a chainring 100, in accordance with an embodiment of the present invention. More specifically, FIG. 11 is a perspective view of the front surface 101 of the chainring 100 and a perspective view of the back surface 103 of chainring 100.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments could be combined. Although some embodiments have been described in a language specific to structural features and/or methodological acts, it is to be understood that the subject matter is not necessarily limited to the specific features or acts described above. Rather, the specific features and acts described above are disclosed by way of illustration and as example forms of implementing the described invention.

What we claim is:

1. A chainring comprising:
a front surface;
a back surface;
a center;
an outer diameter, wherein said chainring has a thickness which varies from a lesser thickness at said outer diameter to a greater thickness nearer said center, said thickness of said chainring substantially similar at a cross-section of said front surface and said back surface such that said chainring is substantially symmetric about a plane dividing said front surface and said back surface along a direction normal to an axial direction of said chainring;
a plurality of teeth about a circumference of said outer diameter of said chainring;
an opening in said center of said chainring, said opening for fixedly coupling said chainring with a crank arm to form a drive side of a crank assembly; and
a depressed region about an inner diameter of said chainring and adjacent to said opening in said center of said chainring, said depressed region to engage with another portion of said crank assembly.

2. The chainring of claim 1, wherein said depressed region extends into said back surface of said chainring.

3. A chainring comprising:
a front surface;
a back surface;
a center;
an outer diameter, wherein said chainring has a thickness which varies from a lesser thickness at said outer diameter to a greater thickness nearer said center, said thickness of said chainring varying substantially the same on said front surface and said back surface such that said chainring is substantially symmetric about a plane dividing said front surface and said back surface along a direction normal to an axial direction of said chainring;
an opening in said center of said chainring, said opening for fixedly coupling said chainring with a crank arm to form a drive side of a crank assembly; and
a depressed region about an inner diameter of said chainring and adjacent to said opening in said center of said chainring, said depressed region to engage with a portion of a crank set of said crank assembly.

4. A chainring comprising:
a front surface;
a back surface;
a center;
an outer diameter, wherein said chainring has a thickness which varies from a lesser thickness at said outer diameter to a greater thickness nearer said center, said thickness of said chainring varying substantially the same on said front surface and said back surface such that said chainring is substantially symmetric about a plane dividing said front surface and said back surface along a direction normal to an axial direction of said chainring;
an opening in said center of said chainring, said opening for fixedly coupling said chainring with a crank arm to form a drive side of a crank assembly; and
a depressed region about an inner diameter of said chainring and adjacent to said opening in said center of said chainring, said depressed region extends into said back surface of said chainring.

5. A bicycle chainring comprising:
a front surface;
a back surface;
a center;
an outer diameter, wherein said bicycle chainring has a thickness which varies from a lesser thickness at said outer diameter to a greater thickness nearer said center, said thickness of said bicycle chainring substantially similar at a cross-section of said front surface and said back surface such that said chainring is substantially symmetric about a plane dividing said front surface and said back surface along a direction normal to an axial direction of said bicycle chainring;
an opening in said center of said bicycle chainring, said opening for fixedly coupling said bicycle chainring with a crank arm to form a drive side of a crank assembly; and
a depressed region about an inner diameter of said bicycle chainring and adjacent to said opening in said center of said bicycle chainring, said depressed region to engage with another portion of said crank assembly, wherein said depressed region extends into said back surface of said chainring.
